(19) United States
(12) Patent Application Publication
(10) Pub. No.: US 2023/0271332 A1
(43) Pub. Date: Aug. 31, 2023

(54) APPARATUS FOR THE AUTOMATED PRODUCTION OF SCREW CONNECTIONS

(71) Applicant: HELLA GmbH & Co. KGaA, Lippstadt (DE)

(72) Inventors: Ludger-Josef GRUENE, Hoexter (DE); Frank JAGOW, Erwitte/ Bad Westernkotten (DE); Matthias MATTENKLOTZ, Geseke-Langeneicke (DE); Thomas Albert ROEBBECKE, Erwitte (DE)

(73) Assignee: HELLA GmbH & Co. KGaA, Lippstadt (DE)

(21) Appl. No.: 18/131,670

(22) Filed: Apr. 6, 2023

Related U.S. Application Data
(63) Continuation of application No. PCT/EP2021/077085, filed on Oct. 1, 2021.

(30) Foreign Application Priority Data
Oct. 7, 2020 (DE) 10 2020 126 189.6

(51) Int. Cl. B25J 15/00; B25J 9/12; B25J 11/00; B25B 23/04; B25J 13/08

(52) U.S. Cl. CPC B25J 15/0019; B25B 23/04; B25J 9/123; B25J 11/005; B25J 13/085; B23P 19/06

(57) ABSTRACT

An apparatus for the automated production of screw connections, having an articulated-arm robot and an effector, which is accommodated on an output element of an end member of the articulated-arm robot so as to be rotatable about an effector axis. The effector is in the form of a screwdriving tool, wherein the apparatus has a mouthpiece for providing a screw, the mouthpiece being accommodated on the end member by means of a linear guide and being movable along the effector axis between a feeding position and at least one screwing position.

This nonprovisional application is a continuation of International Application No PCT/EP2021/077085, which was filed on Oct. 10, 2021, and which claims priority to German Patent Application No 10 2020 126 189.6, which was filed in Germany on Oct. 07, 2020, and which are both herein incorporated by reference.

### BACKGROUND OF THE INVENTION

### Field of the Invention

The present invention relates to an apparatus for the automated production of screw connections, comprising an articulated-arm robot and an effector which is accommodated on an output element of an end member of the articulated-arm robot so as to be rotatable about an effector axis.

### Description of the Background Art

Articulated-arm robots are usually equipped with an automatic screwing machine for the automated production of screw connections. Such an automatic screwing machine comprises the screwdriving tool and an associated drive with an electric motor. In the prior art, approaches are known in which the screwdriving tool is also driven, at least in part, by the output element on the end member of the articulated-arm robot.

For example, EP 2 729 281 B1, which corresponds to US 2014/0135987, discloses a screwdriving device for rotary joining and/or rotary loosening of screws, in particular, using a robot with a driven axis of rotation, wherein the robot carries an independently driven rotating device with a rotating tool as an effector, wherein the rotating device is designed for fast tightening/untightening of the screw, and wherein the driven axis of rotation of the robot is provided for tightening/loosening the screw. The entire rotating device is accommodated on the rotatable output element of the robot and is consequently set in rotation by the robot-side rotary drive when it is rotated, wherein a switchable blocking device provides for torque transmission to the rotating tool. EP 2 729 281 B1 thus proposes a hybrid approach in which the robot loosens or tightens the screw by rotating its axis of rotation, whereas the rest of the screwing process is completed by the separate drive of the flange-mounted rotating device. In this case, the angle of rotation of the robot-side output element is disadvantageously severely limited because a coiling of the feed lines to the rotating device must be prevented.

DE 20 2014 100 334 U1 discloses a robot tool with a frame and an integrated powertrain for rotating an output element (in particular a screwdriver bit) of a rotating tool, wherein the powertrain is designed for rotary actuation by a robot and has a torque amplifier connected to the output element for amplifying a drive torque of the robot. Optionally, an additional motorized powertrain integrated into the robot tool can also act on the output element here. It is provided that the robot tool is to be mounted on an external, fixed guiding device, which represents a significant limitation in terms of the flexibility of the entire apparatus.

### SUMMARY OF THE INVENTION

It is therefore an object of the present invention to propose a refinement of an apparatus for the automated production of screw connections, comprising an articulated-arm robot and an effector, which is accommodated on an output element of an end member of the articulated-arm robot so as to be rotatable about an effector axis.

The invention includes the technical teaching that the effector is designed as a screwdriving tool, wherein the apparatus has a mouthpiece for providing a screw, the mouthpiece being accommodated on the end member by means of a linear guide and being movable along the effector axis between a feeding position and at least one screwing position.

The invention is based on the idea of using the output element on the end member of the articulated-arm robot for the infinite rotation of the screwdriving tool, so that a further drive, such as is known from automatic screwing machines in the prior art, can be dispensed with. The output element is an integral part of the articulated-arm robot, so that a common articulated-arm robot from the prior art can be used without further modifications in the apparatus of the invention. The screwdriving tool is designed, for example, as a screwdriver blade or a bit holder with screw bit.

Further, it is proposed according to the invention to arrange a mouthpiece for providing a screw on the end member of the articulated-arm robot which forms a housing of the output element and does not participate in the rotation thereof. This creates an apparatus in which the automatic provision of screws can be carried out in a manner known from the prior art, i.e., either by means of a pick-and-place process or, as will be explained in more detail below, by means of an automatic feeding device associated with the mouthpiece. By means of the linear guide of the invention, the mouthpiece can be moved along the effector axis, i.e., along the screw axis of the screwdriving tool, between a feeding position, which is provided for feeding a screw into the mouthpiece, and at least one screwing position. In the screwing positions, the screwdriving tool is in engagement with a received screw, wherein the screw protrudes from the mouthpiece at least partially. The screwing process is completed by rotating the screwdriving tool by means of the output element of the articulated-arm robot with the adapted feed of the end member of the articulated-arm robot along the effector axis. Simultaneously with the advance of the end member, the mouthpiece is moved in the opposite direction along the effector axis by means of the linear guide, so that the screw and, if necessary, the tip of the screwdriving tool emerge from the mouthpiece.

The complete substitution of the separate drive of the screwdriving tool, as used by prior art automatic screwing machines, by the robot-side output element advantageously leads to a reduction of the weight absorbed by the robot and of the operational costs to be expended. In combination with the inventive accommodation of the mouthpiece on the end member of the robot, this substitution is not at the expense of the degree of automation of the screw connection production that can be carried out with the apparatus.

The apparatus of the invention can have an electric drive for moving the linear guide. The electric drive can also be located on the end member of the articulated-arm robot and enables precise advancing of the mouthpiece into the feeding and screwing positions.

Furthermore, the apparatus of the invention can have at least one spring which pretensions the mouthpiece into the feeding position. This represents a cost-effective alternative to the aforementioned embodiment with an electric drive. In a screwing process carried out with it, the mouthpiece is to be brought into contact with a workpiece to be screwed and, during the advance, the end member of the articulated-arm robot must work against the spring in order to push the screw picked up on the screwdriving tool out of the mouthpiece, i.e., in order to move the mouthpiece into a screwing position. When the articulated-arm robot is removed from the workpiece after the screwing process, the mouthpiece is pushed back into the feeding position by the spring.

Further, the apparatus of the invention can have at least one position sensor for determining the position of the mouthpiece. Such a sensor is preferably designed for determining the position of the linear guide, from which the corresponding position of the mouthpiece can be inferred. A detection of the position of the mouthpiece is used for process automation.

The apparatus can have a hollow tube which can be subjected to negative pressure and is accommodated on the end member by means of a bearing arm, wherein the screwdriving tool extends axially in the hollow tube, and wherein the hollow tube has a mouth opening for the airtight seating of a screw head. The screwdriving tool thus runs, at least with a section associated with the screw, in an evacuated hollow tube and the screw, which is placed airtight against the mouth opening of the hollow tube, experiences a holding effect due to the negative pressure, which prevents unintentional loss of the screw in the course of the process. The hollow tube and the screwdriving tool cannot be moved relative to one another, so that the dimensions must be such that, in the case of an airtight seating of the screw, the screwdriving tool engages exactly in the screw head drive.

With further advantage, the apparatus of the invention can have a screw feeding device by means of which a screw can be fed from a feed hose, which can be supplied with compressed air, into the mouthpiece in the feeding position. A combination of a screw feeding device known from the prior art is thus possible with the apparatus of the invention, because according to the invention the mouthpiece is not involved in the rotation of the screwdriving tool, and thus represents a fixed receptacle for the feeding device. In this regard, the feed hose is usually fed from a reservoir of screws, which are fed to the feeding device by means of compressed air.

The articulated-arm robot can have six axes of rotation, wherein the effector axis is formed by the sixth axis of rotation, and wherein the end member is rotatable about the fifth axis of rotation.

The apparatus of the invention can have a torque sensor, associated with the screwdriving tool, and/or force sensor. This makes it possible to control and document the screwing process. Typically, suitable torque or force sensors are already integrated into the articulated-arm robots.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a cross-sectional view of a first exemplary embodiment of the apparatus of the invention;

FIG. 2 shows a cross-sectional view of a second exemplary embodiment; and

FIG. 3 shows a perspective view of the second exemplary embodiment.

### DETAILED DESCRIPTION

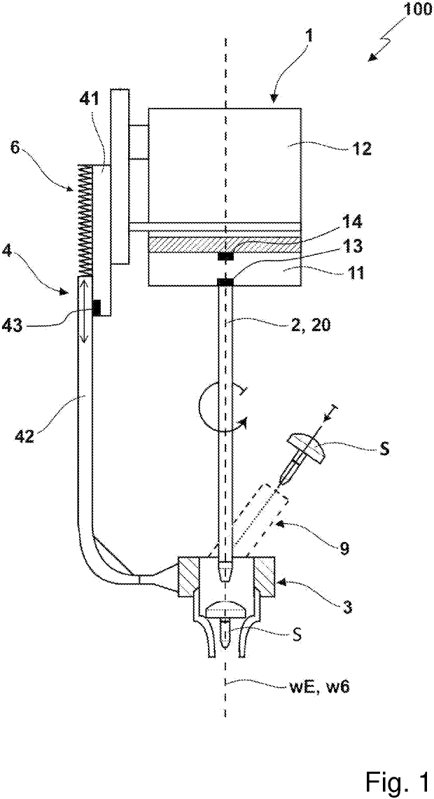

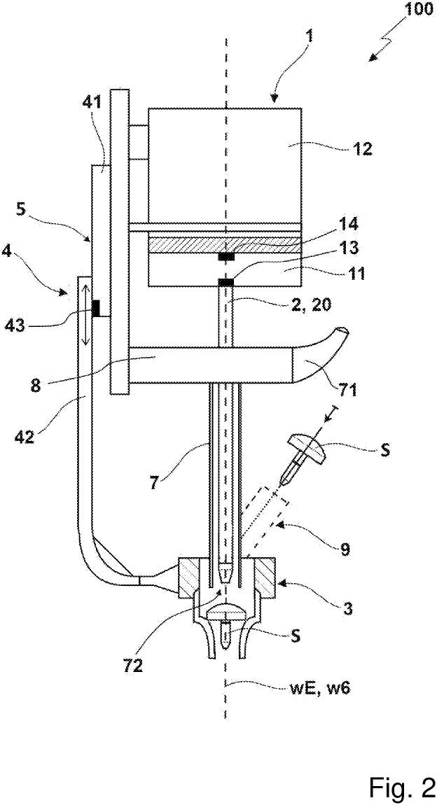

FIG. 1 and FIG. 2 show cross-sectional views of advantageous exemplary embodiments of apparatus 100 of the invention, comprising articulated-arm robot 1, of which in each case only end member 12 with output element 11 rotatable thereon is shown, further comprising effector 2, accommodated on output element 11, in the form of screwdriving tool 20, and mouthpiece 3 accommodated on end member 12 by means of linear guide 4. When output element 11 rotates, screwdriving tool 20 rotates about the effector axis wE, which corresponds to the sixth axis of rotation w6 of articulated-arm robot 1, and mouthpiece 3 can be moved along the effector axis wE by means of linear guide 4. For this purpose, linear guide 4 has seat 41, which is rigidly arranged on end member 12, and movable slide 42, on which mouthpiece 3 is accommodated. In the exemplary embodiment of FIG. 1, slide 42 is moved against seat 41 by means of advancing end member 12 with simultaneous contact of mouthpiece 3 with a workpiece, and in the exemplary embodiment of FIG. 2 by actuating electric linear drive 5. The position of slide 42 relative to seat 41, and thus the position of mouthpiece 3, can be determined by means of position sensor 43. Torque sensor 13 and force sensor 14, which are integrated into articulated-arm robot 1 here by way of example, are used for further monitoring of the screwing process with apparatus 100.

In FIG. 1 and FIG. 2, mouthpiece 3 is in the feeding position in each case, which corresponds to an extreme position of mouthpiece 3 and in which screwdriving tool 20 is not in engagement with the drive at the head of screw S. In the feeding position of mouthpiece 3, a screw S can be fed into mouthpiece 3 by means of feeding device 9, which has a channel opening into mouthpiece 3 from diagonally below the plane of the drawing, typically by means of compressed air via a connected hose. When mouthpiece 3 is moved into a screwing position, i.e., along the effector axis wE in the direction of end member 12, screwdriving tool 20 engages with the screw S and subsequently the screw S is pushed out of mouthpiece 3 at an end and can be screwed into a workpiece provided for this purpose with rotation of output element 11. In the exemplary embodiment of FIG. 1, spring 6 acting on slide 42 is designed as a helical compression spring, in the force-free state of which mouthpiece 3 is in the feeding position. When screwdriving tool 20 is advanced through mouthpiece 3, work must be performed by the articulated-arm robot against spring 6, wherein mouthpiece 3 must be in contact with a workpiece or the like for support.

In the exemplary embodiment of FIG. 2, seat 41 and slide 42 of linear guide 4 are designed as components of an electric drive 5, and slide 42 can thus be actively moved with mouthpiece 3. Furthermore, screwdriving tool 20 runs in sections in hollow tube 7, which can be subjected to negative pressure and is accommodated on bearing arm 8 and is rigidly arranged via the latter on end member 12 of articulated-arm robot 1. Vacuum connection 71, which can be used to connect a pump, is used to apply the vacuum. In order to make the rearward exit of screwdriving tool 20 from hollow tube 7 as airtight as possible, a sealing ring, for example, is expediently integrated. The front-side mouthpiece opening of hollow tube 7 is designed for the air-tight seating of the screw head of the screw S, so that the screw S is sucked onto hollow tube 7 when mouthpiece 3 is moved to a screwing position, whereby a robust screwing process can be realized. In the embodiment shown here, screwdriving tool 20 is rotatable in hollow tube 7 but not moveable relative thereto. The blade tip of screwdriving tool 20 must therefore be suitably spaced from mouthpiece opening of hollow tube 7 in order to engage positively in the screw head drive of a screw S which is in air-tight contact.

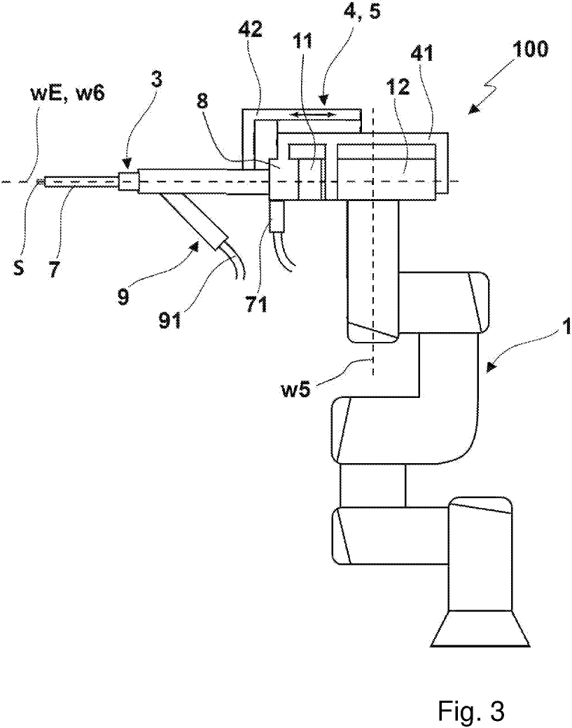

FIG. 3 shows an overall perspective view of the exemplary embodiment of apparatus 100 of the invention corresponding to FIG. 2. Articulated-arm robot 1 has six axes of rotation, wherein end member 12 is rotatable about the fifth axis of rotation w5. In FIG. 3, mouthpiece 3 is in a screwing position in which hollow tube 7, in the interior of which the screwdriving tool runs concealed and on which the screw S is accommodated, projects far out of mouthpiece 3, so that a screwing process can be initiated by rotating output element 11. Feeding device 9 can be connected via feed hose 91 to a screw conveying device known from the prior art, so that automatic feeding of screws into mouthpiece 3 in the feeding position is possible.

The invention is not limited in its implementation to the preferred exemplary embodiment described above. Rather, a number of variants are conceivable which make use of the shown solution even in the case of fundamentally different embodiments. All features and/or advantages emerging from the claims, description, or drawings, including structural details and spatial arrangements, can be essential to the invention both alone and in the most diverse combinations.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An apparatus for automated production of screw connections, the apparatus comprising:
an articulated-arm robot;
an effector that is accommodated on an output element of an end member of the articulated-arm robot so as to be rotatable about an effector axis, the effector being in the form of a screwdriving tool; and
a mouthpiece for providing a screw, the mouthpiece being accommodated on the end member via a linear guide and being movable along the effector axis between a feeding position and at least one screwing position.

2. The apparatus according to claim 1, further comprising an electric drive to move the linear guide.

3. The apparatus according to claim 1, further comprising at least one spring that pretensions the mouthpiece into the feeding position.

4. The apparatus according to claim 1, further comprising at least one position sensor to determine a position of the mouthpiece.

5. The apparatus according to claim 1, further comprising a hollow tube adapted to be subjected to negative pressure and is accommodated on the end member via a bearing arm, wherein the screwdriving tool extends axially in the hollow tube, and wherein the hollow tube has a mouth opening for the airtight seating of a screw head.

6. The apparatus according to claim 1, further comprising a screw feeding device via which a screw is fed from a feed hose, which is supplied with compressed air, into the mouthpiece in the feeding position.

7. The apparatus according to claim 1, wherein the articulated-arm robot has six axes of rotation, wherein the effector axis is formed by the sixth axis of rotation, and wherein the end member is rotatable about the fifth axis of rotation.

8. The apparatus according to claim 1, further comprising a torque sensor associated with the screwdriving tool and/or further comprising a force sensor.
